(19) United States
(12) Patent Application Publication
(10) Pub. No.: US 2022/0216559 A1
(43) Pub. Date: Jul. 7, 2022

(54) BATTERY HOLDER

(71) Applicant: Abraham LEVENTHAL, Surfers Paradise, Queensland (AU)

(72) Inventor: Mark Williams KIEHNE, Calamvale (AU)

(73) Assignee: Abraham LEVENTHAL, Surfers Paradise, Queensland (AU)

(21) Appl. No.: 17/609,740

(22) PCT Filed: May 21, 2020
(86) PCT No.: PCT/AU2020/000042

§ 371 Date: Nov. 8, 2021

(30) Foreign Application Priority Data
May 21, 2019 (AU) 2019901719

(51) Int. Cl. H01M 50/216; B65D 83/00; B65D 83/04

(52) U.S. Cl. CPC H01M 50/216; B65D 2585/88; B65D 83/0409; B65D 83/0005

(57) ABSTRACT

A battery holder (10) comprising a translucent, extruded polypropylene body (11) having a rectangular passage (12) therethrough. The body (11) has an insertion end (13) and a remote ejection end (14). The battery holder body (11) has an elongate axis extending from the insertion end (13) to the remote end (14), and the axial passage (12) extends therethrough from the insertion end (13) to the remote end (14). The axial passage (12) is of substantially constant cross section transverse said axis, the cross section being selected to permit frictionally retarded movement of a battery (16) therethrough of from the insertion end (13) of the passage (12) to a remote ejection end (14). The axial passage is of a length selected to enclose a plurality of the batteries laid in series in an edge to edge manner.

### FIELD OF THE INVENTION

This invention relates to a battery holder. This invention has particular application to a battery holder for so-called coin and button batteries, and for illustrative purposes the invention will be described with reference to this application. However, we envisage that this invention may find use in other applications such as holders for small camera batteries and other flat disc shaped items or the like.

### BACKGROUND OF THE INVENTION

The reference to any prior art in this specification is not, and should not be taken as, an acknowledgement or any form of suggestion that the referenced prior art forms part of the common general knowledge in Australia.

Coin and button batteries are a recognized safety hazard for, especially, small children. Ingestion of coin and button batteries by children has resulted in many cases of serious injury and some deaths. Regulation in some jurisdictions have compelled the use of screw fixings and other means for reducing the ability of children to remove coin and button batteries from the appliances that they power or maintain in standby. However, packaging for coin and button batteries remain for the most part single use, point-of-sale blister packs. After a battery is dispensed from the blister pack and deployed to replace a battery, one is left with a useless blister pack and an exposed, expended battery.

Recycling is also a problem. Individual batteries (some containing mercury, cadmium or other toxic materials) tend to be disposed of in general waste and end up in landfill. Unprotected batteries disposed of inappropriately may undergo electrical poling causing fire hazard in mass collection recycling bins.

### SUMMARY OF THE INVENTION

In one aspect, the invention provides a battery holder including a body having an elongate axis and an axial passage therethrough, the axial passage being of substantially constant cross section transverse said axis, the axial passage being of a length to enclose a plurality of the batteries laid in series in an edge to edge manner, the cross section of the axial passage being selected to permit frictionally retarded movement of the batteries therethrough from an insertion end of said passage to a remote ejection end of said passage.

Preferably, the cross section of the axial passage is selected to correspond to the cross-section shape of a battery.

Preferably, the body comprises a top wall, a bottom wall and side walls therebetween defining the axial passage, wherein the top wall and the bottom wall engage the upper and lower surfaces of a battery to retard the movement of the battery through the passage.

Preferably, the insertion end is relieved by an arcuate cut out in the top wall providing a space into which a finger may push a used battery into the passage.

Preferably, a floor portion of the bottom wall corresponding to the cut out is adapted to impede withdrawal of a battery partially inserted into the passage.

Preferably, the remote ejection end is shaped with a top arcuate extension and a bottom arcuate extension of the top and bottom walls respectively, the extensions being adapted to provide a pinch support for a battery pushed out of the remote end.

Preferably, the battery holder further comprises a follower slidably mounted in the passage, the follower having an arcuate leading face to engage the edge of the last new battery and an arcuate trailing face which a first of the expired batteries engages.

Preferably, the follower is a dark or bright coloured slider visible through the body and forms a visible indication between remaining new batteries and inserted depleted batteries.

Preferably, the battery holder further comprises an end cap adapted to be inserted into the insertion end of the passage, the end cap having a tongue shaped to cover the cutout.

Alternatively, the passage includes a broad, shallow portion formed along the inside surface of the bottom wall to accommodate the change of section imposed by the negative cap of button batteries.

Alternatively, the passage is of a broad inverted T-section where a void exists above the inserted battery at the inside surface of the top wall to allow passage of an adhesive seal of the battery.

Preferably, the passage is of constant cross section formed by extrusion and provided with resistance nibs or non-return structures by hot processing of the extruded body material to provide the frictionally retarded movement of the batteries.

Preferably, the end cap includes a central pusher selected to enter the passage.

Preferably, the battery holder is provided as a point-of-sale package for a plurality of batteries that functions as a dispenser for new batteries and a receptacle for expired ones.

Preferably, the follower cooperates with the remote end to prevent the follower passing out of the remote end.

Preferably, the body includes a longitudinal slot with the follower having a formation extending through the slot, such that follower can be moved by a user's finger engaging the formation, wherein the follower can be used as an ejector of new batteries.

In another aspect the present invention resides broadly in battery holder including a body having an elongate axis and an axial passage therethrough of substantially constant cross section transverse said axis, the cross section being selected to permit frictionally retarded movement of a battery therethrough of from an insertion end of said passage to a remote end, the axial passage being of length selected to enclose a said battery.

The body may comprise a thermoplastic polymer body.

The body is preferably an extrusion of constant cross section, although it is envisaged that the body may be for example injection moulded. The polymer is preferably a plastic polyolefin material such as low density polyethylene or polypropylene. The polymer material may be opaque of may be translucent for reasons discussed hereinafter.

The axial passage may be selected to conform to some or all of the dimensional parameters of a battery, with the only constraint being to allow frictionally retarded movement of a battery therethrough. The battery may have a shape that is generally a solid of rotation about an axis, and the cross section may be selected to receive the battery with its axis transverse the passage. For example, where the battery is a button battery, the cross section may be selected to accept the battery edge-on.

The section may be closely conforming to the battery shape. For example, the bore may accommodate the slight change of section between the positive case and negative cover of a button battery. However, in practice a simple rectangular section will suffice for a button battery. In the case of the battery being a zinc/air hearing aid battery having an adhesive seal over an air hole on the top of the battery, and the passage may be of a broad inverted T-section where a void exists above the inserted battery at the leg of the T to allow passage of the adhesive seal.

While constant cross section passages will be generally preferred for simplicity and cost of manufacture, it is envisaged that the bore may be produced with resistance nibs or non-return structures. For example, when the passage is of constant cross section formed by extrusion it may be provided with resistance nibs or non-return structures by hot processing of the extruded body material.

The length of the axial passage may provide for accommodation of a single battery or may be sufficient to accommodate at least two or more batteries.

The insertion end of the passage is preferable defined by an end portion of the polymer body having a partially relieved section selected to allow push insertion of a battery into the passage but impede withdrawal of a partially inserted battery by pinching an edge thereof. For example, in the case of a generally rectangular section polymer body having a rectangular passage selected to receive a button battery, a cut out of an upper, major width part of the polymer body at the insertion end may allow a user's finger to shunt a battery into the passage. The effect of which is that material that is not cut-out hinders removal of the battery so inserted. The cut-out may be advantageously arcuate to accommodate the shape of a fingertip during insertion.

It is envisaged that the body member will usually be straight but can in the alternative be curved. One or both of the insertion and remote ends may be provided with e.g. end caps. End caps may simply engage or encompass an end of the polymer body or may include a central pusher selected to enter the passage.

The apparatus may comprise a holder for expended batteries only. In this case the remote end may be stoppered or configured whereby the inserted batteries cannot pass out of the remote end. The apparatus may be instead a loadable cartridge for dispensing a plurality of button batteries.

In a yet further alternative, the apparatus may comprise a point-of-sale package for a plurality of batteries that functions as a dispenser for new batteries and a receptacle for expired ones. The polymer body may be blister packaged for sale or may be moulded with or assembled to a swing hanger portion.

Where the apparatus is used as a dispenser, the passage may be associated with a follower to form a visible indication between remaining new batteries and inserted depleted batteries. For example, the follower may comprise a dark or bright slider visible through the polymer body and located in the passage. The slider may have arcuate leading and trailing faces to nest on the edge of the last new battery and the first of the expired batteries, respectively. The follower may cooperate with the remote end to prevent the follower passing out of the remote end. For example, the section of the follower may cooperate with an axial guide that is not engaged by the batteries and is obstructed at the remote end.

In the case of dispensers for zinc/air batteries, the passage may be a broad inverted T-section, where a void exists at the leg of the T to allow passage of the zinc/air batteries without dislodging the adhesive seal over the air hole.

The point-of-sale apparatus may be clear or opaque as before, or may be made opaque with by overprinting, or a combination.

### BRIEF DESCRIPTION OF THE DRAWINGS

The invention will be described with reference to the following non-limiting embodiment of the invention as illustrated in the drawings and wherein:

FIG. 1 is an isometric view of a battery holder in accordance with a first embodiment of the present invention;

FIG. 2 is an isometric view of an end cap for use with the battery holder of FIG. 1;

FIG. 3 is an isometric view of a battery holder in accordance with a second embodiment of the present invention;

FIG. 4 is an isometric view of an end cap for use with the battery holder of FIG. 3;

FIG. 5 is an isometric view of a battery holder in accordance with a third embodiment of the present invention, with an end cap in exploded assembly;

FIG. 6 is a reverse isometric view of the end cap of the battery holder of FIG. 5; and

FIG. 7 is a cross sectional view of a battery holder in accordance with a fourth embodiment of the present invention.

### DESCRIPTION OF EMBODIMENTS

In FIGS. 1 and 2 there is provided a battery holder 10 comprising a translucent, extruded polypropylene body 11 having a rectangular passage 12 therethrough. The body 11 has an insertion end 13 and a remote ejection end 14.

The battery holder body 11 has an elongate axis extending from the insertion end 13 to the remote end 14, and the axial passage 12 extends therethrough from the insertion end 13 to the remote end 14. The axial passage 12 is of substantially constant cross section transverse said axis, the cross section being selected to permit frictionally retarded movement of a battery 16 therethrough of from the insertion end 13 of the passage 12 to a remote ejection end 14. The axial passage is of a length selected to enclose a plurality of the batteries laid in series in an edge to edge manner.

The passage 12 is generally of constant cross section, and the axial passage 12 cross-section shape is selected to conform to dimensional parameters of a battery.

The battery 16 typically has a shape that is generally a solid of rotation about an axis, and the cross section is selected to receive the battery with its axis transverse the passage. The battery in the example is a coin or button battery, and the cross section of the passage 12 is selected to accept the battery edge-on.

In other words, the battery 16 is a generally flat disc shape, and the passage 12 has an elongated rectangular cross-section shape similar to the cross-section shape of the battery 16.

The body 12 comprises a top wall 71, a bottom wall 72 and side walls 73 therebetween. As mentioned, the cross section of the passage 12 is selected to permit frictionally retarded movement of a battery 16 therethrough. In this example, the top wall 71 and the bottom wall 72 engage the upper and lower surfaces of a battery 16 to retard the movement of the battery 16 through the passage 12. As shown, the passage 12 is of a length to receive a plurality of batteries 16 arranged in an edge to edge manner.

The insertion end 13 is relieved by an arcuate cut out 15 in the top wall 71, providing a space into which a finger may push a used battery 16 into the passage 12. The floor 17 (part of the bottom wall 72) of the relief provided by the cut-out 15 is adapted to impede withdrawal of a battery 16 partially inserted into the passage 12. The floor 17 for example can include a raised formation or the floor 17 can be partially raised to engage an edge of the battery adjacent the insertion end 13. The passage 12 is dimensioned to provide a frictionally impeded sliding fit for the battery 16.

The remote ejection end 14 is shaped with a top arcuate extension 20 and a bottom arcuate extension 21 of the top and bottom walls 71 and 72 respectively. The extensions 20 and 21 are adapted to provide a tong-like pinch support for a battery 16 pushed out of the remote end 14 as the friction impeding movement of the battery diminishes. This helps to reduce the likelihood of the exiting battery 16 being dropped.

Slidably mounted in the rectangular passage 12 is a follower 18 comprising a biconcave, rectangular-section slug having a leading edge 22 adapted to push on a fresh battery 16 in the passage 12 and a trailing edge 23 adapted to be pushed by the leading used battery 16b (or a blank substituting for one) being inserted into or urged along the passage 12.

In use, an expired battery 16a is pushed into the insertion end 13 of the passage 12, displacing the line of fresh batteries 16, follower 18 and previously inserted expired battery 16b, and ejecting the terminal fresh battery 16 into the tong-like embrace of the top arcuate extension 20 and bottom arcuate extension 21. The fresh battery may then be removed for use. When there are no more fresh batteries 16, the follower 18 shows at the remote end 14. The follower 18 cooperates with the remote end 14 to prevent the follower 18 passing out of the remote end 14.

The follower 18 is a dark or bright coloured slider visible through the body and forms a visible indication between remaining new batteries and inserted depleted batteries. The follower slider 18 has arcuate leading and trailing faces to nest on the edge of the last new battery and the first of the expired batteries, respectively. An optional cap 24 has an integral cap body 25 and tongue 26, adapted to be inserted into the insertion end of the passage 12. The tongue 26 can be shaped to cover the cutout 15.

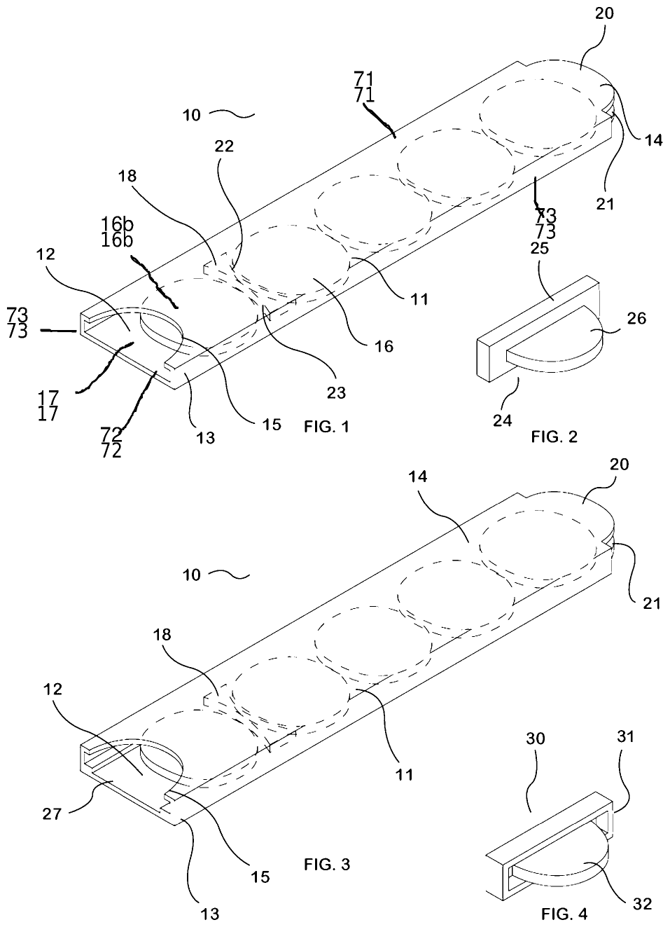

In the embodiment of FIGS. 3 and 4 (where like numerals indicate like features of FIGS. 1 and 2), there is further provided a passage 12 having a broad, shallow portion 27 formed along the inside surface of the bottom wall 71. The shallow portion 27 is added to the generally rectangular section passage 12 of FIG. 1, to accommodate the change of section imposed by the negative cap of some button batteries.

The battery in this embodiment for example can be a zinc/air hearing aid battery having an adhesive seal over an air hole on the top of the battery, and the passage 12 is of a broad inverted T-section where a void exists above the inserted battery at the leg of the T to allow passage of the adhesive seal.

A cap 30 is integrally formed and comprises a rectilinear wall portion 31 forming a hollow section closed at one end by a wall portion to form a box. Integrally formed on the wall portion in the box is a tongue 32. Between the wall portion 31 and the tongue 32 is a space adapted to receive the insertion end 13 of the body 11, with the tongue 32 locating in the passage 12.

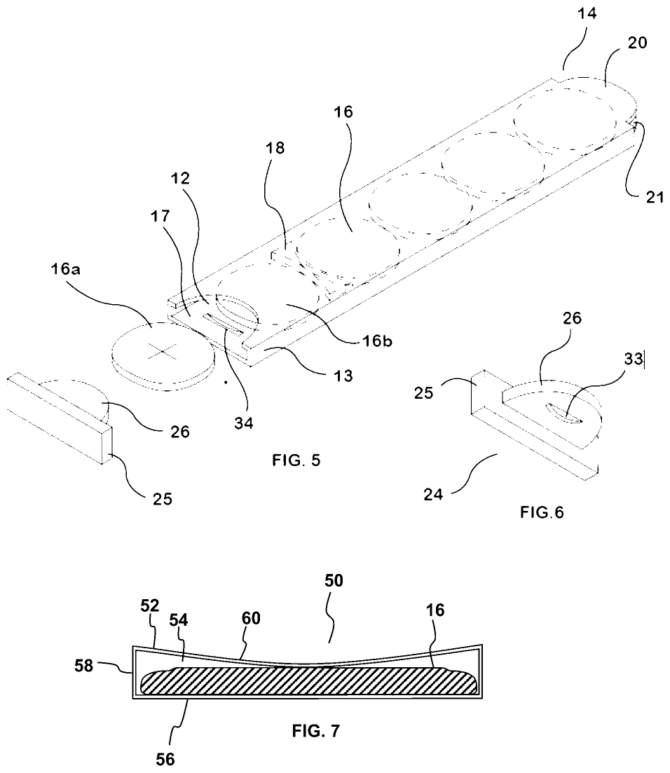

In the embodiment of FIGS. 5 and 6 (where like numerals indicate like features of FIGS. 1 and 2), there is further provided a nib 33 adapted to engage a pit 34 formed in the floor 17 and adapted to provide engagement security for the cap 24 in its engagement with the insertion end 13.

In use, an expired battery 16a is pushed into the insertion end 13 of the passage 12, displacing the line of fresh batteries 16, follower 18 and previously inserted expired battery 16b, and ejecting the terminal fresh battery 16 into the tong-like embrace of the top arcuate extension 20 and bottom arcuate extension 21 at the remote ejection end 14. The fresh battery may then be removed for use. When there are no more fresh batteries 16, the follower 18 shows at the remote end 14.

FIG. 7 illustrates a cross-sectional view of a battery holder 50 according to a further embodiment of the invention, the cross-sectional view being transverse to an axis of a body 52 thereof.

The battery holder 50 is similar to the holder 10, but instead of having a rectangular passage 12, the top wall 60 has a concave passage 54 through the body. In particular, the body 52 comprises a planar base 56, from which sidewalls 58 upwardly extend. A curved upper wall 60 extends between the sidewalls 58 to define the concave passage 54 with the planar base 56 and sidewalls 58.

The curved upper wall 60 extends downwardly onto an upper surface of a battery 16 and engages therewith to thereby provides a frictionally impeded sliding fit for the battery 16.

Apparatus in accordance with the foregoing embodiments confine spent batteries in a manner that cannot be swallowed by children. As a dispenser, the batteries are confined until needed in a package that accepts the old battery while delivering the new. If child does swallow a spent battery it is in a protective plastic shield that will prevent poling charge causing burning of internal body parts.

The passage in one example is of constant cross section formed by extrusion and provided with resistance nibs or non-return structures by hot processing of the extruded body material. The length of the axial passage is sufficient to accommodate at least two batteries, preferably being at least 4 batteries.

The cut out at the insertion end is shaped to allow a user's finger to shunt a battery into the passage. The cut-out is arcuate to accommodate the shape of a fingertip during battery insertion.

In another embodiment, one or both of the insertion and remote ends are provided with end caps. The end cap for the insertion end includes a central pusher selected to enter the passage.

The invention thus provides a holder for expended batteries wherein the remote end is configured whereby the inserted expended batteries cannot pass out of the remote end. The invention in another aspect is a loadable cartridge for dispensing a plurality of button batteries. The invention in another aspect is a point-of-sale package for a plurality of batteries that functions as a dispenser for new batteries and a receptacle for expired ones.

It will of course be realised that while the above has been given by way of illustrative example of this invention, all such and other modifications and variations thereto as would be apparent to persons skilled in the art are deemed to fall within the broad scope and ambit of this invention as is set forth in the claims appended hereto.

In a possible modification, the body can include a longitudinal slot with the follower 18 having a formation extending through the slot, such that follower 18 can be moved by a user's finger engaging the formation. In this manner, the follower 18 can be used as the ejector of new batteries if the old batteries are misplaced.

1. A battery holder including a body having an elongate axis and an axial passage therethrough, the axial passage being of substantially constant cross section transverse said axis, the axial passage being of a length to enclose a plurality of the batteries laid in series in an edge to edge manner, the cross section of the axial passage being selected to permit frictionally retarded movement of the batteries therethrough from an insertion end of said passage to a remote ejection end of said passage.

2. The battery holder of claim 1 wherein the cross section of the axial passage is selected to correspond to the cross-section shape of a battery.

3. The battery holder of claim 1 wherein the body comprises a top wall, a bottom wall and side walls therebetween defining the axial passage, wherein the top wall and the bottom wall engage the upper and lower surfaces of a battery to retard the movement of the battery through the passage.

4. The battery holder of claim 3 wherein the insertion end is relieved by an arcuate cut out in the top wall providing a space into which a finger may push a used battery into the passage.

5. The battery holder of claim 4 wherein a floor portion of the bottom wall corresponding to the cut out is adapted to impede withdrawal of a battery partially inserted into the passage.

6. The battery holder of claim 3 wherein the remote ejection end is shaped with a top arcuate extension and a bottom arcuate extension of the top and bottom walls respectively, the extensions being adapted to provide a pinch support for a battery pushed out of the remote end.

7. The battery holder of claim 1 further comprising a follower slidably mounted in the passage, the follower having an arcuate leading face to engage the edge of the last new battery and an arcuate trailing face which a first of the expired batteries engages.

8. The battery holder of claim 7 wherein the follower is a dark or bright coloured slider visible through the body and forms a visible indication between remaining new batteries and inserted depleted batteries.

9. The battery holder of claim 4 further comprising an end cap adapted to be inserted into the insertion end of the passage, the end cap having a tongue shaped to cover the cutout.

10. The battery holder of claim 3 wherein the passage includes a broad, shallow portion formed along the inside surface of the bottom wall to accommodate the change of section imposed by the negative cap of button batteries.

11. The battery holder of claim 3 wherein the passage is of a broad inverted T-section where a void exists above the inserted battery at the inside surface of the top wall to allow passage of an adhesive seal of the battery.

12. The battery holder of claim 1 wherein the passage is of constant cross section formed by extrusion and provided with resistance nibs or non-return structures by hot processing of the extruded body material to provide the frictionally retarded movement of the batteries.

13. The battery holder of claim 9 wherein the end cap includes a central pusher selected to enter the passage.

14. The battery holder of claim 1 provided as a point-of-sale package for a plurality of batteries that functions as a dispenser for new batteries and a receptacle for expired ones.

15. The battery holder of claim 7 wherein the follower cooperates with the remote end to prevent the follower passing out of the remote end.

16. The battery holder of claim 7 wherein the body includes a longitudinal slot with the follower having a formation extending through the slot, such that follower can be moved by a user's finger engaging the formation, wherein the follower can be used as an ejector of new batteries.
